(19) United States
(12) Patent Application Publication
(10) Pub. No.: US 2010/0135505 A1
(43) Pub. Date: Jun. 3, 2010

(54) Very high intelligibility mass notofication system

(76) Inventors: David J. Graebener, Reno, NV (US); David J. Michno, Carson City, NV (US); Kenneth H. Winter, Bowdoin, ME (US)

Correspondence Address: RICHARD C. CALDERWOOD, 2775 NW 126TH AVE, PORTLAND, OR, 97229-8381, US

(21) Appl. No.: 12/315,402

(22) Filed: Dec. 3, 2008

(51) Int. Cl. H04R 27/00

(52) U.S. Cl. 381/82

(57) ABSTRACT

A mass notification system (MNS) loudspeaker having very high intelligibility. The MNS loudspeaker includes a plurality of transducers arranged in a symmetric pattern around an axis, so as to produce a substantially cylindrical wave front of sound pressure. The loudspeakers are coupled to a cap, and form a cylinder whose inner diameter is large enough to slip over a pole to which the loudspeakers are to be mounted. The under side of the cap may rest atop the pole. An inner cylinder encloses an air volume behind the transducers for acoustic loading and environmental protection of the transducers. An optional telescoping stand retracts into the inner cylinder.

### BACKGROUND OF THE INVENTION

1. Technical Field of the Invention

This invention relates generally to acoustic loudspeaker systems, and more specifically to mass notification systems such as are used in broadcasting spoken public address announcements in very large venues.

2. Background Art

Mass notification systems (MNSs) are used in a variety of outdoor and indoor venues, for providing audio signaling simultaneously to a large number of listeners. MNSs are used on outdoor venues such as stadiums, fairgrounds, parking lots, theme parks, amusement parks, military bases, school campuses, and the exterior areas of cruise ships, aircraft carriers, and the like. MNSs are also used in indoor venues such as concert halls, sports arenas, exhibition halls, airports, aircraft hangers, warehouses, stores, shopping malls, and the interior areas of cruise ships, military ships, and the like. MNSs are typically used to broadcast spoken messages, rather than e.g. music. This reduces the need for them to reproduce full frequency signals across the entire spectrum of human hearing, and enables them to use loudspeaker technologies which may not be suitable for full frequency systems. But MNSs have design challenges of their own.

The primary design criterion is often “intelligibility” and is measured using the Common Intelligibility Scale (CIS) defined by the International Electrotechnical Commission Standard 60849, or using the Speech Intelligibility Index (STI) defined by the American National Standards Institute Standard S3.5, or, less commonly, using the Articulation Index, the Articulation Loss of Consonants system, the Phonetically Balanced Word Scores system, the Modified Rhyme Test, or the Speech Transmission Index.

One major factor contributing to reduced intelligibility is out-of-phase arrival at the listener's ear of signals emanating from multiple sources. One cause of this multi-path problem is simply reverberation and echoes; some sound travels directly from the loudspeaker to the listener over a path of length X, while sound from that same loudspeaker may also travel over a bouncing path of different length Y, thus arriving at the listener's position a fraction of a second later due to the longer path. Another significant cause of the multi-path problem is that MNSs almost of necessity use a multitude of loudspeakers distributed throughout the venue. Each loudspeaker is likely to be a unique distance from any particular listener, so even the direct paths will cause different arrival times, and the problem is further compounded by each loudspeaker having its own, unique echo pathways to each listening position.

It is almost unavoidable that there be more than one loudspeaker in a large venue. Otherwise, in order to make the sound pressure level (SPL) sufficient at the remotest regions of the venue to provide a sufficiently high signal-to-ambient-noise ratio for the audio signal to be heard, the SPL in the immediate vicinity of a single loudspeaker would necessarily be uncomfortably, or even dangerously, high. The only viable solution is to have a large number of quieter loudspeakers scattered throughout the venue.

Other factors contributing to reduced intelligibility are the comb filtering, lobing, and other interference issues that arise when two or more loudspeakers are near each other and have overlapping sound dispersion patterns. Practical design limitations prevent loudspeakers from being designed so as to have super-precisely-defined dispersion patterns. Therefore, in order to prevent “dead spots”, it is necessary to overlap the dispersion patterns of adjacent loudspeakers. This causes interference issues which can be detrimental to intelligibility.

Another significant design consideration for MNSs, especially those which are intended for outdoor or marine installations, is weatherproofing to protect against moisture, ultraviolet light, and so forth.

FIG. 1 illustrates an MNS loudspeaker system 10 such as may be used in a mass notification system, according to the prior art such as that available from American Technology Corporation of San Diego, Calif. An MNS would typically have a multitude of such systems scattered throughout the venue, but, for convenience, only a single system is shown. The loudspeaker system is typically mounted at or above the ear level of standing persons, and is commonly mounted on a pole 12 as shown. Pole mounted arrays are often located 25-40 feet above the ground. It is desirable to mount the loudspeakers in a high location, to prevent persons from standing too close to the transducers themselves, where the sound pressure level may be unacceptably high.

The system includes a plurality of—typically four—loudspeakers 14 arranged around the pole on equal 90° spacing. Each loudspeaker is fastened to the pole by an upper bracket 16 and a lower bracket 18, which are bolted or screwed to the pole.

In order to improve the loudspeaker's life in an outdoor environment, each loudspeaker is equipped with a rain bill 20.

Other details, such as the electrical connections, are not significant in the context of this invention, and have been omitted in the interest of clarity and simplicity. Those of ordinary skill in the art are well able to select from any variety of suitable, existing technologies to handle such matters, within the purview of this invention.

FIG. 2 is a top view of the MNS loudspeaker system 10 of FIG. 1, illustrating the pole 12, loudspeakers 14, top mounting brackets 16, and rain bills 20.

FIG. 25 is a polar response graph resulting from a computer simulation of a 4-transducer MNS system such as that of FIG. 1. The graph shows response at 1 kHz, 2 kHz, 3 kHz, 4 kHz, and 5 kHz around the MNS system. It is plotted with a reference position arbitrarily assigned at the position marked 0°, and the transducers modeled as being at the 0°, 90°R, 90°L, and 180° positions. The outermost dashed circle represents a 0 dB reference level, and the successive inner dashed circles represent 5 dB, 10 dB, 15 dB, 20 dB, 25 dB, and 30 dB down levels, respectively. The closer to center a signal is at any particular angle, the quieter that signal will be when the listener is located at a listening position radially outward at that angle.

For a 1 kHz signal, the prior art 4-transducer system has acceptably good performance at all listening angles. At the 45° and 135° positions, which are half-way between adjacent transducers, the 1 kHz signal is only down about 1 dB versus the on-axis (0°) reference level. At 2 kHz, the prior art 4-transducer system has already begun to demonstrate an unacceptable drop of 5 dB in the 45° and 135° positions. At 3 kHz the signal is down a whopping 18 dB at the 45° and 135° angles; in other words, it is only 1/64^{th} as loud there as it is at 0°, 90°, or 180° directly in front of a transducer. The 4 kHz and 5 kHz signals suffer such severe lobing as to be essentially absent at any position not directly in front of a transducer. The prior art systems are very inadequate, if human speech intelligibility is important.

### BRIEF DESCRIPTION OF THE DRAWINGS

FIG. 1 shows a pole-mounted MNS loudspeaker system according to the prior art.

FIG. 2 shows the MNS loudspeaker system of FIG. 1 in top view.

FIG. 3 shows a pole-mounted MNS loudspeaker system according to one embodiment of this invention.

FIG. 4 is a top view of the MNS loudspeaker system of FIG. 3 with the raincap component removed for visibility.

FIG. 5 is an exploded view of the MNS loudspeaker system of FIG. 3.

FIGS. 6 and 7 are top and bottom perspective cross-sectioned views, respectively, of the raincap mounting mechanism of FIG. 3.

FIGS. 8 and 9 are top and bottom perspective cross-sectioned views, respectively, of the lower mounting mechanism of FIG. 4.

FIG. 10 shows a 270° embodiment of the MNS loudspeaker system of FIG. 3, as mounted to an outside corner.

FIG. 11 shows a 90° embodiment of the MNS loudspeaker system of FIG. 3, as mounted to an inside corner.

FIG. 12 shows a 180° embodiment of the MNS loudspeaker system of FIG. 3, as mounted to a wall.

FIGS. 13 and 14 show an MNS loudspeaker according to another embodiment of this invention, in upper and lower perspective cross-sectioned views, respectively.

FIG. 15 shows an outer cylinder mounting frame to which the individual transducers of FIG. 13 are mounted.

FIG. 16 shows a trapezoidal implementation of a planar magnetic transducer.

FIG. 17 shows a conical MNS loudspeaker according to another embodiment of this invention, utilizing the trapezoidal transducers of FIG. 16.

FIG. 18 shows an outer conical mounting frame such as may be used in FIG. 17.

FIG. 19 shows another embodiment of a MNS loudspeaker in which the array is enlarged such that the transducers do not touch edge-to-edge.

FIG. 20 shows the MNS loudspeaker of FIG. 19 in a slightly canted top view, with the raincap removed for visibility of the other parts.

FIG. 21 shows an outer frame such as may be used in the MNS loudspeaker of FIG. 19.

FIG. 22 shows a portable MNS system according to another embodiment of this invention.

FIGS. 23 and 24 show one embodiment of a portable MNS system, with a retractable stand in a furled configuration and an unfurled configuration, respectively.

FIG. 25 shows the polar response of the 4-transducer MNS system of FIG. 1.

FIG. 26 shows the vastly better polar response of an 8-transducer MNS system according to this invention.

FIG. 27 shows the still better polar response of a 16-transducer MNS system according to this invention.

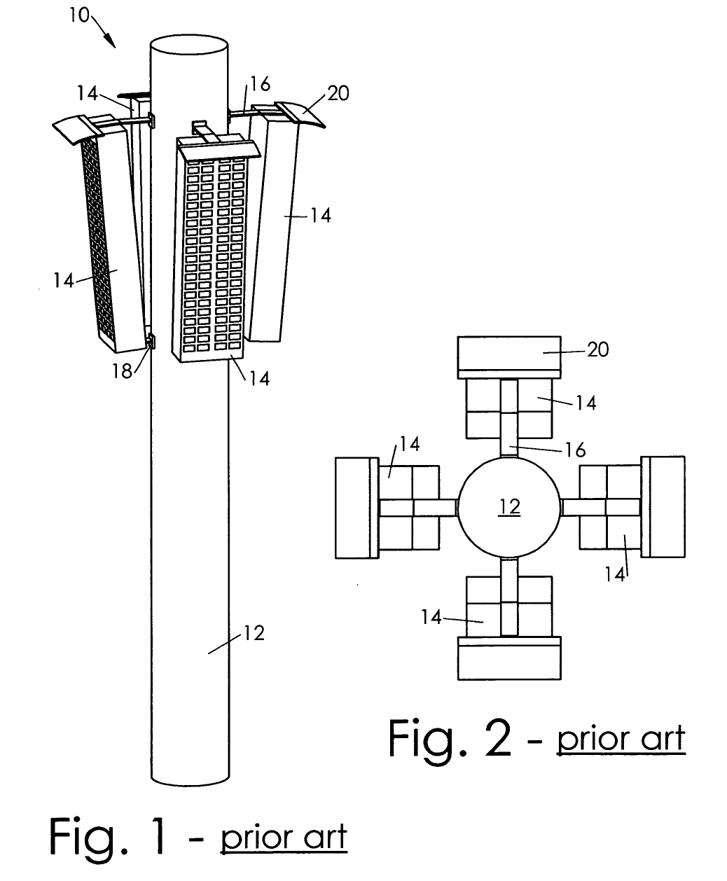

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

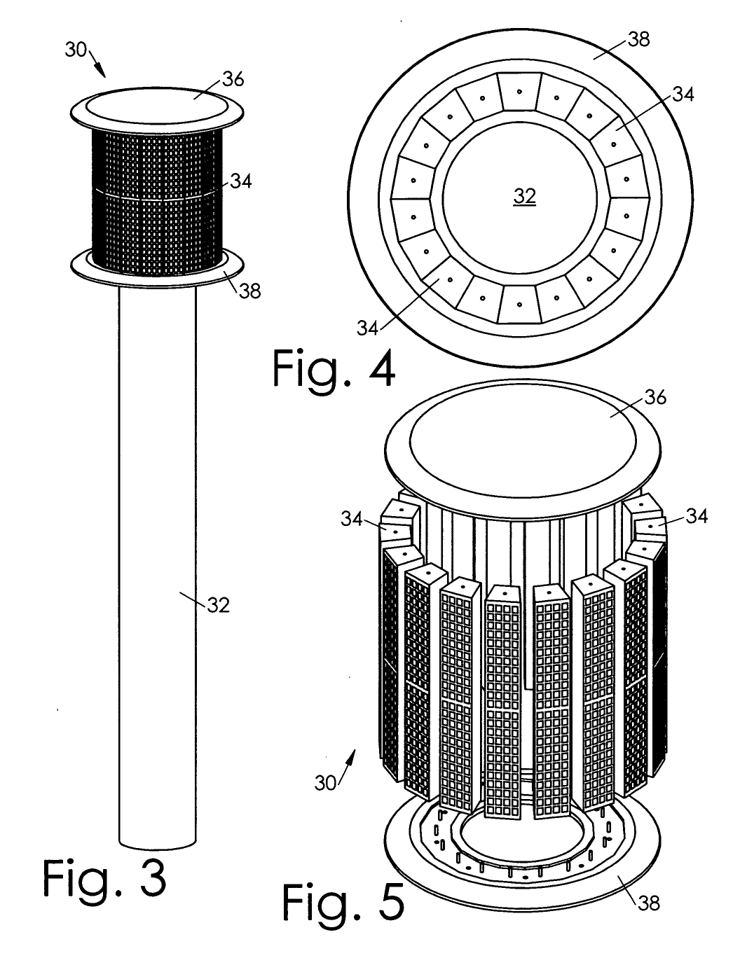

FIG. 3 illustrates an MNS loudspeaker system 30 according to one embodiment of this invention, such as may be used in a mass notification system. For clarity of illustration, only a single such loudspeaker system is shown, although typically an MNS will have a large number of them scattered throughout the venue. The loudspeaker system is shown as mounted on a pole 32, but it could also be e.g. hung from a ceiling or mounted to a wall.

The loudspeaker system includes at least eight transducers 34 (and eighteen are shown) arranged in a substantially symmetric pattern around an axis of the loudspeaker system. The number of transducers should be determined, in some measure, according to the horizontal dispersion pattern of the particular transducers employed. It is desirable to use a sufficiently large number of transducers that the array presents a cylindrical wave front and behaves approximately like a pulsating cylinder in the target frequency range. It is desirable to reduce or eliminate comb filtering, lobing, and other interference artifacts which can arise if an insufficient number of transducers is used.

Each transducer may, in some embodiments, be an elongated planar magnetic transducer. In one such embodiment, each transducer is approximately 25 inches tall.

Rather than each transducer being individually mounted directly to the pole, as was done in the prior art, in the present invention each transducer is instead mounted directly to a rain cap 36 and, optionally, to a base 38. Alternatively, the transducers may be coupled directly to each other, or to a common frame (not shown).

In one embodiment, the rain cap serves triple duty; it not only fastens the transducers together, it also provides protection from rain etc., and serves to mount the transducers to the pole. Installation of this loudspeaker system is greatly simplified, as compared to the transducer-by-transducer installation process of the prior art. The manufacturer can ship a fully assembled loudspeaker system, which the installer can simply slip over the top of the pole.

FIG. 4 is a top view of the loudspeaker system of FIG. 3, with the rain cap removed to provide visibility of the transducers 34 and the optional base 38 which fits around the pole 32.

FIG. 5 is an exploded view of the loudspeaker system 30 of FIG. 3. A variety of techniques can be used to fasten each transducer 34 to the rain cap 36 and to the base 38. In this embodiment, each transducer comprises a self-enclosed loudspeaker assembly, either having a cabinet or a self-enclosed motor structure.

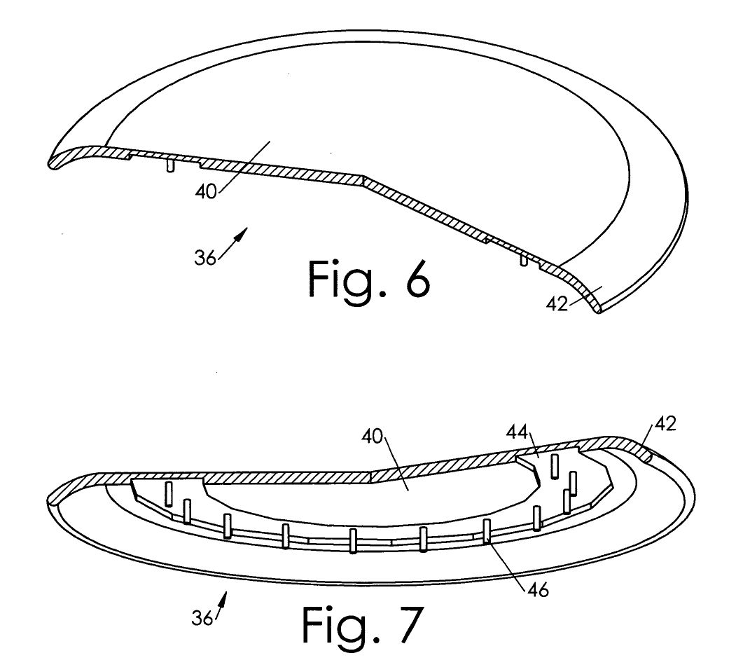

FIG. 6 illustrates one embodiment of a rain cap 36, in cross-sectioned view from a top perspective. The rain cap includes a central body 40 which is sufficiently strong to support the loudspeakers (not shown). The rain cap optionally but advantageously includes a brim 42 which extends beyond the transducers to provide protection from rain, sun, and so forth. The brim may be integrally formed with the body, or it may be attached to the body.

FIG. 7 illustrates the rain cap 36 in cross-sectioned view from a bottom perspective. The body 40 may include a shaped channel 44 for holding the transducers in a tightly controlled orientation and positioning. The body may be provided with e.g. mounting posts 44 for indexing and retaining the individual transducers. The posts may be integrally formed with, or attached to, the body. Alternatively, the transducers may be fastened to the rain cap by bolts extending downward through the rain cap, but it is desirable to provide gaskets or other means of preventing moisture intrusion through the holes.

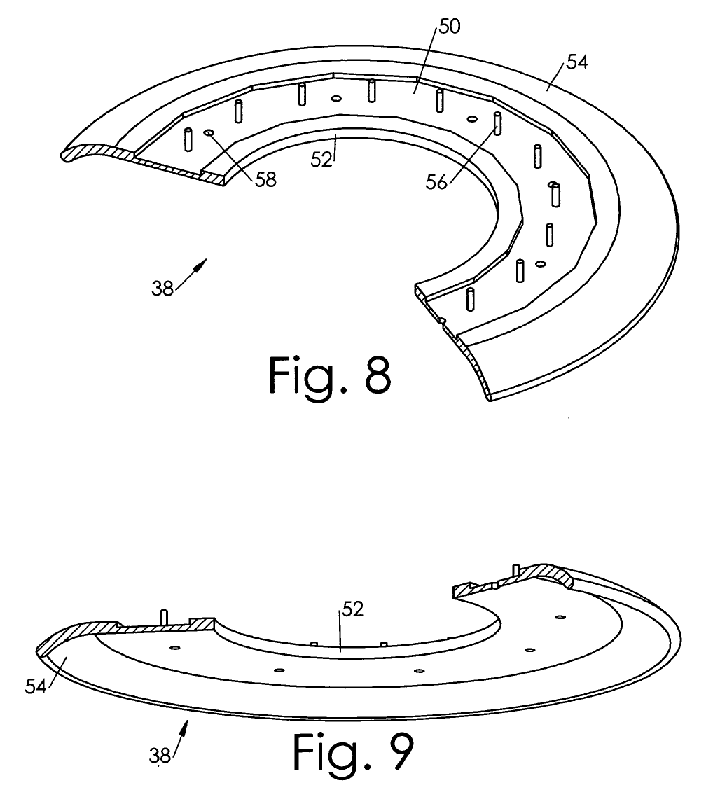

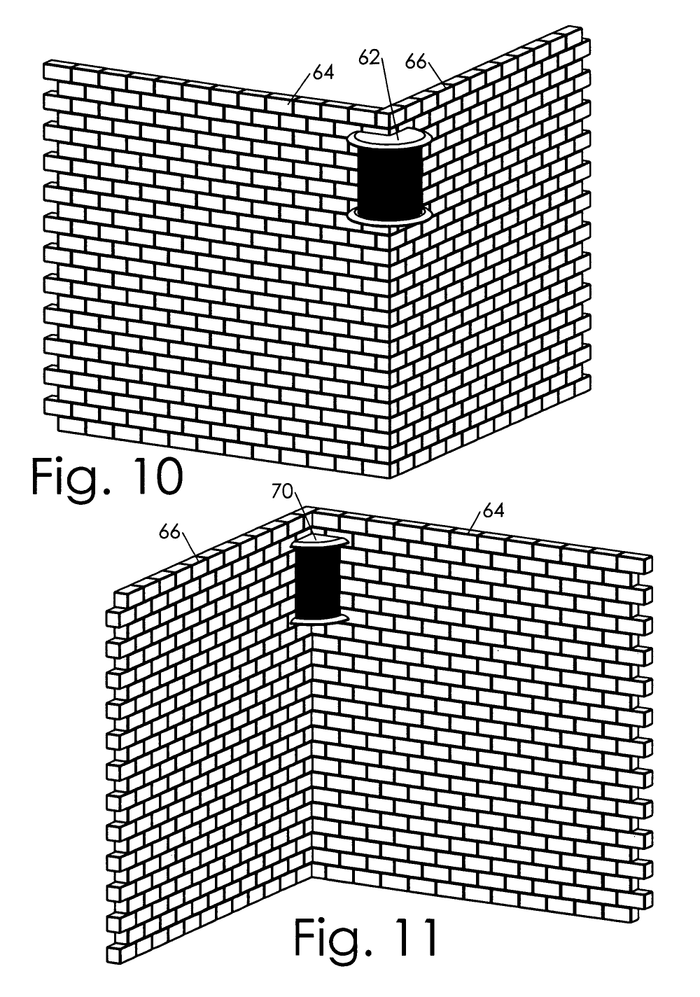

FIG. 8 illustrates one embodiment of a base 38, in cross-sectioned view in a top perspective. The base may include a shaped channel 50 for holding the transducers in a tightly controlled orientation and positioning. The base includes a central hole 52 enabling it to pass over the pole (not shown). The body may include a brim 54 which extends beyond the transducers. The body may be provided with e.g. mounting posts 56 for indexing and retaining the individual transducers. The posts may be integrally formed with, or attached to, the body or, alternatively the transducers may be coupled to the base with bolts extending upwardly through holes in the base. The channel may be provided with one or more weep holes 58 to prevent rain water and other moisture from collecting in the channel and soaking the bottoms of the transducers.

In some embodiments, in which it is desirable that the transducers be mounted lower than the top of the pole (not shown), the rain cap may be provided with a central hole like that of the base, enabling the rain cap to slip lower than the top of the pole. In such embodiments, bolts or other suitable means can be used to affix the rain cap to the pole at the desired location.

FIG. 9 illustrates the base 38 in a cross-sectioned view from a bottom perspective.

FIG. 10 illustrates a 270° implementation of an MNS loudspeaker 62 mounted to an outside corner where two walls 64, 66 meet. In this embodiment, the loudspeaker would include only ¾ the number of transducers as would a similar 360° loudspeaker.

The transducers are coupled together into a single, contiguous group which covers 270° of the 360° cylinder.

FIG. 11 illustrates a 90° implementation of an MNS loudspeaker 70 mounted to an inside corner where two walls 64, 66 meet. In this embodiment, the loudspeaker would include only ¼ the number of transducers as would a similar 360° loudspeaker

The transducers are coupled together into a single, contiguous group which covers 90° of the 360° cylinder.

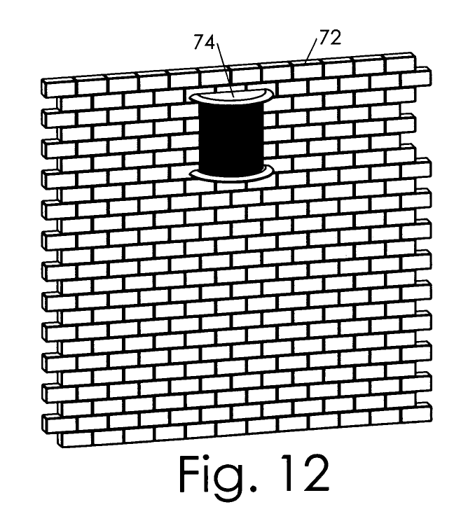

FIG. 12 illustrates a 180° implementation of an MNS loudspeaker 74 mounted to a wall 72. In this embodiment, the loudspeaker would include only ½ the number of transducers as would a similar 360° loudspeaker

The transducers are coupled together into a single, contiguous group which covers 180° of the 360° cylinder.

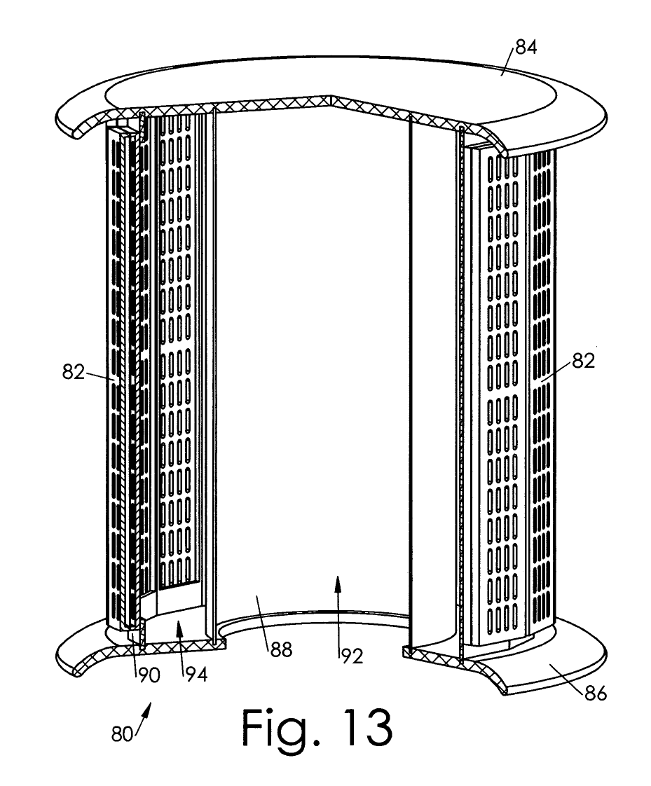

FIG. 13 illustrates an MNS loudspeaker 80 according to another embodiment of this invention. The MNS loudspeaker includes a plurality of planar magnetic transducers 82 coupled to a frame 90. A rain cap 84 and an optional lower ring 86 are also coupled to the frame. An inner cylinder 88 is coupled to the raincap and to the lower ring. A sealed air volume 94 is enclosed in the space between the frame (and back sides of the transducers), the inner cylinder, the raincap, and the lower ring. This enclosed air volume serves as the cabinet air load for the transducers. It also seals and protects the back sides of the transducers from the outside environment, which may be contaminated with moisture, particulates, and so forth.

Optionally, various ones of the frame, the inner cylinder, the raincap, and the lower ring may be formed as integral, monolithic components rather than as separate components.

In one embodiment, the MNS loudspeaker mounts to a pole (not shown) by slipping over the top of the pole. In such an embodiment, the lower ring is equipped with a hole 92 sized to fit over the pole.

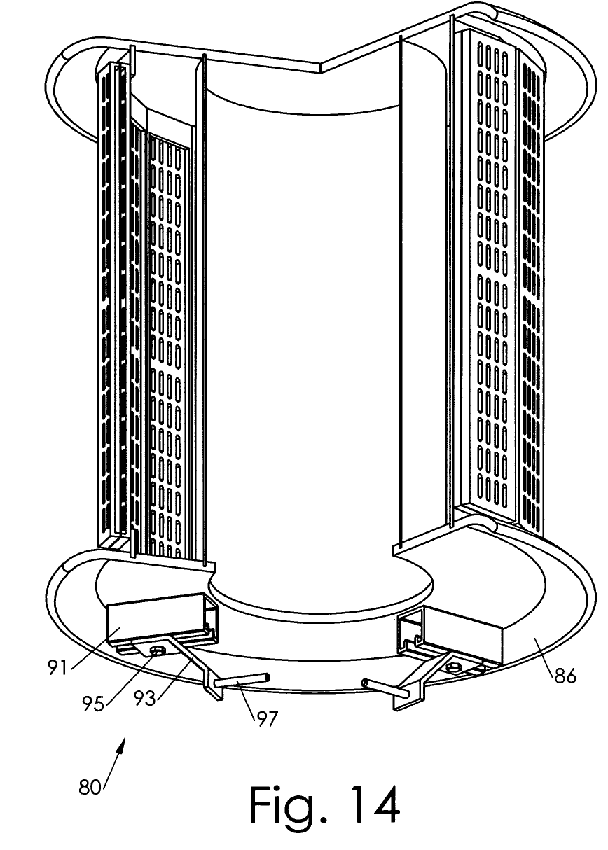

FIG. 14 illustrates the MNS loudspeaker 80 from a lower perspective view, and further illustrates one embodiment of a mounting system which may be used to affix the loudspeaker to the pole (not shown). The lower ring is equipped with one or more, and preferably three or more, adjustable mounting brackets. In one embodiment, each bracket includes a length of channeled steel beam 91 such as that available from Unistrut Corporation. An angled bracket 93 is coupled to the beam by a bolt 95 which engages a nut (not visible) riding inside the channel of the beam. The angled bracket is coupled to the pole by a lag bolt 97. Once the lag bolts are snugged into position, the bolts 95 are tightened, locking the nut into position in the beam.

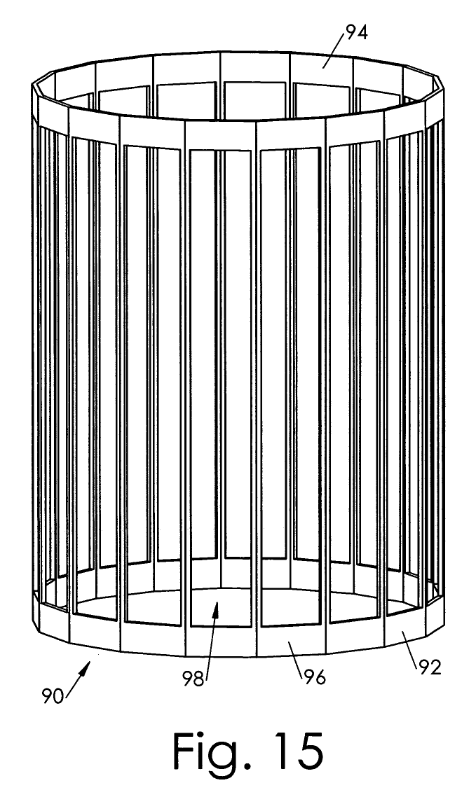

FIG. 15 illustrates a frame 90 such as may be used in the MNS loudspeaker of FIG. 13. The frame includes a lower portion 92 adapted to engage with or be coupled to the lower ring (not shown), and an upper portion 94 adapted to engage with or be coupled to the raincap (not shown). Viewed in gross, the frame has a generally cylindrical shape. This generally cylindrical shape includes a plurality of facets or faces 96 each contoured to engage the back surface of a respective one of the transducers (not shown). Optionally, each facet includes a hole 98 ventilating the rear surface of the transducer's diaphragm into the enclosed air volume between the frame and the inner cylinder (not shown) of the loudspeaker. A variety of sealing mechanisms, such as gaskets or o-rings, may be used to seal the mating surfaces of the frame and the transducer; these are well within the ordinary skill of loudspeaker manufacturers, and are omitted from the drawings here in the interest of clarity.

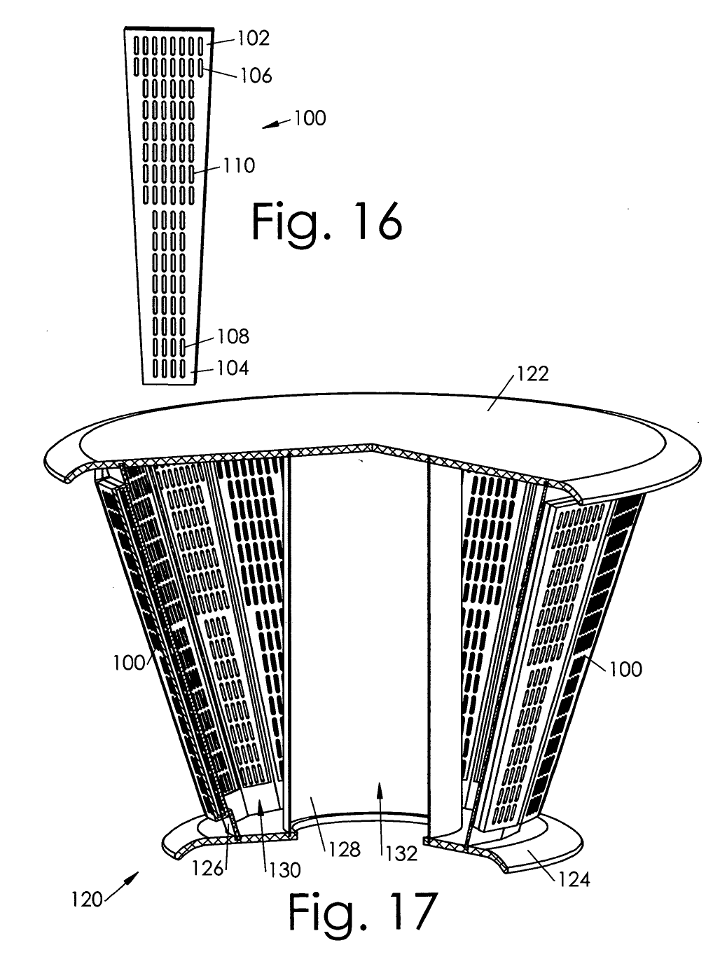

FIG. 16 illustrates a trapezoidally shaped transducer 100 which may be employed in an MNS loudspeaker according to another embodiment of this invention. The transducer includes a wide end 102 and a narrow end 104. In embodiments in which the front surface of the transducer includes ventilation holes or slots, the number and/or size of these may be varied from the wide end to the narrow end of the transducer. In the example shown, the wide end includes one or more rows 106 having a large number of slots, the narrow end includes one or more rows 108 having a small number of slots, and the middle includes one or more rows 110 having an intermediate number of slots.

In implementations in which the trapezoidal transducer is constructed as a planar magnetic transducer, the wide end may include a greater number of columns of magnets than the lower end.

In other embodiments, the transducer need not be strictly trapezoidal in shape, but may take on other shapes having a wide end and a narrow end.

FIG. 17 illustrates an MNS loudspeaker 120 which utilizes the trapezoidal transducer of FIG. 16. The loudspeaker has, in gross, a shape which is a cone section. The loudspeaker includes a raincap 122 which optionally is larger than the lower ring 124. The transducers 100 are coupled to a generally conical frame 126. The inner cylinder 128 may be cylindrical (as shown, although an optical illusion may present some readers with an impression that it is slightly conical with a larger bottom end), or it may be conical, as desired, and encloses an air volume 130. The ring includes an opening 132 sized to fit over the pole (not shown).

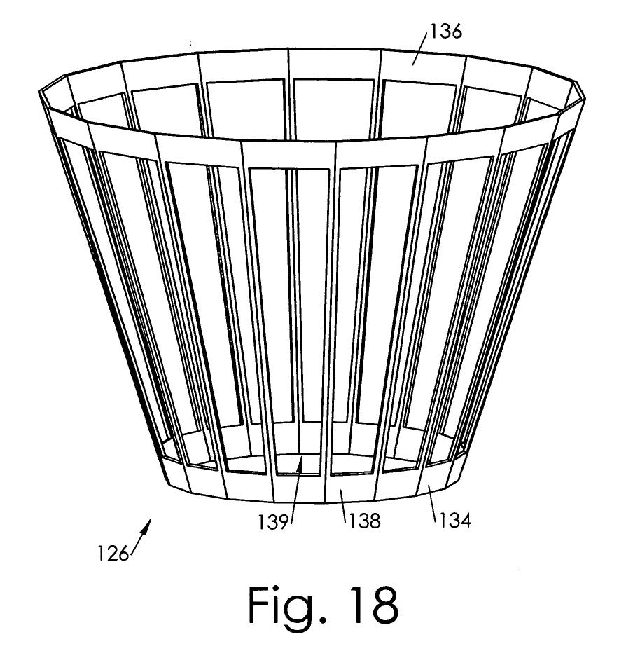

FIG. 18 illustrates the generally conical frame 126 of FIG. 17. The frame includes a lower portion 134 which engages the lower ring, an upper portion 136 which engages the raincap, facets 138 for coupling to the transducers, and optional holes 139 for ventilating the rear surfaces of the transducers' diaphragms.

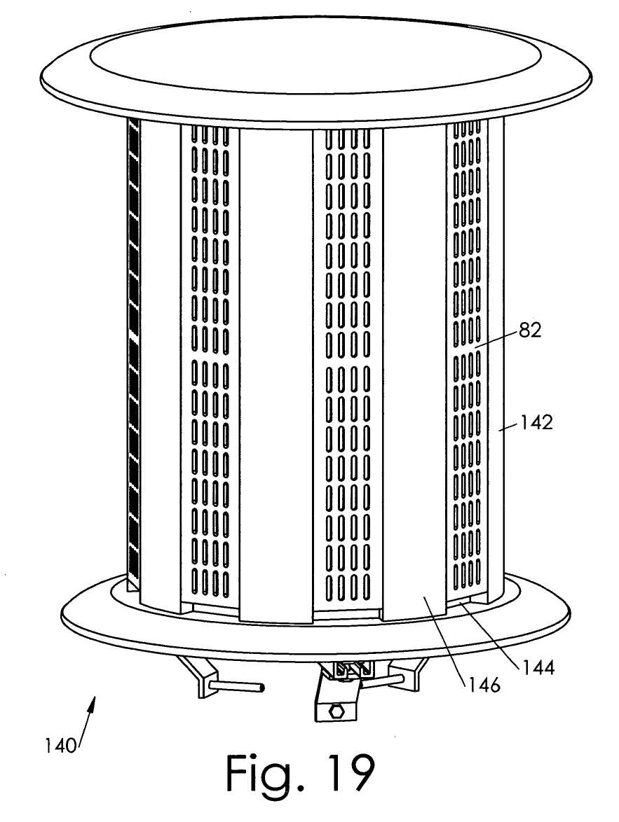

FIG. 19 illustrates an MNS loudspeaker 140 according to another embodiment of this invention. The MNS loudspeaker includes as few as eight transducers 82. Each transducer is sufficiently narrow (left to right in the drawing) that if eight transducers were packed edge to edge, the inner diameter of the octagonal “cylinder” they form would have a diameter too small to fit around some common poles. Therefore, in the MNS loudspeaker 140, the transducers are spaced apart, rather than being packed edge to edge. This is not especially detrimental, given that MNSs operate in the “far field”.

The transducers are coupled to first segments 144 of the frame which are shaped to mate with them and provide a good air seal. Between the first segments, the frame includes second segments 146 to which there are not transducers coupled; the second segments provide the spacing between adjacent transducers. Optionally but advantageously, the second segments may be substantially aligned with the front faces of the transducers, to provide a smooth front baffle and reduce edge diffractions.

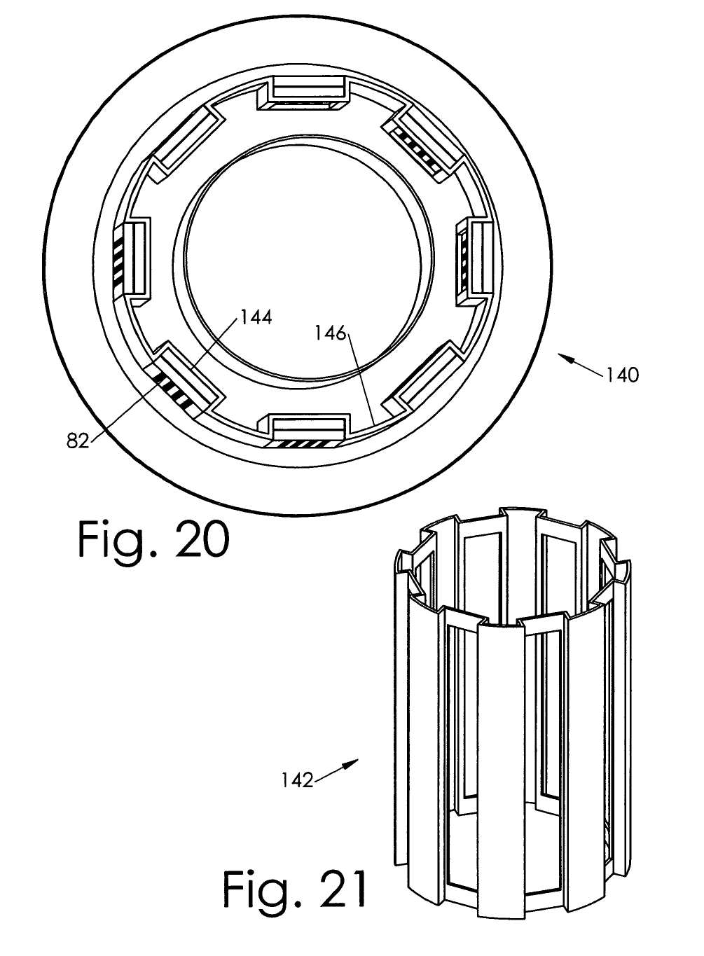

FIG. 20 illustrates the MNS loudspeaker 140 in a slightly canted top view, with the raincap removed, providing a better view of the first segments 144 to which the transducers 82 are mounted and the second segments 146 between the transducers. In some embodiments, the fronts of the second segments have a linear cross-section, but in others, such as that shown, they are arc segments. The arc segments may either be simple segments of a circle, or they may be slightly more complex curves so as to be tangent to the front faces of the transducers.

FIG. 21 illustrates the frame 142 in perspective view, providing a clearer view of the various segments.

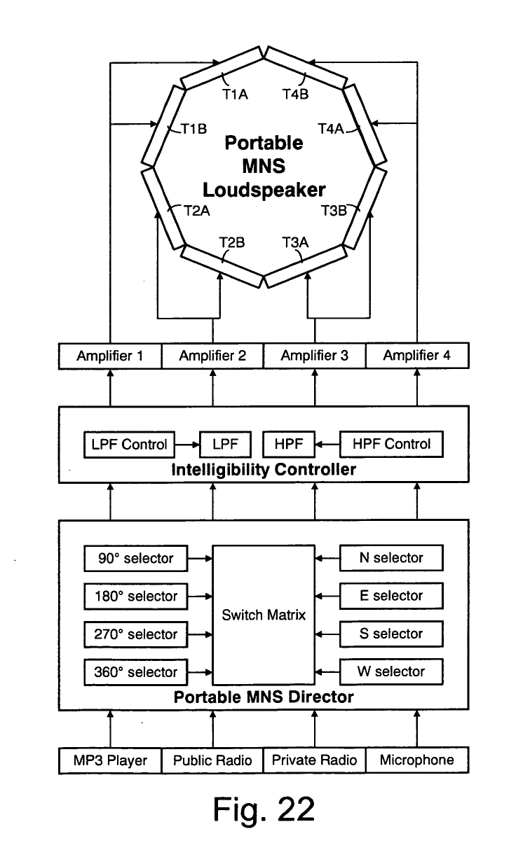

FIG. 22 illustrates one embodiment of a portable MNS system. The system includes a portable MNS loudspeaker including at least eight transducers. In one embodiment, there are 4*N transducers coupled into four sets of N transducers each, and N is a positive integer greater than 1.

Each set of transducers can be independently driven. In the example shown, N=2; the first set includes transducers T1A and T1B coupled to be driven by Amplifier 1, the second set includes transducers T2A and T2B coupled to be driven by Amplifier 2, the third set includes transducers T3A and T3B coupled to be driven by Amplifier 3, and the fourth set includes transducers T4A and T4B coupled to be driven by Amplifier 4. In another embodiment, there may be just a single amplifier (as all the transducers are being driven with the same signal) with a downstream switch mechanism (not shown) for selecting which sets of transducers are driven.

The system further includes a Portable MNS Director unit which receives source signals from one or more internal and/or external audio signal sources. By way of example only, the system is illustrated as having: an MP3 player; a public radio receiver for receiving FM radio, AM radio, satellite radio, and/or television audio signals; a private radio receiver for receiving secure or private audio signals from e.g. a command post; and a microphone input for receiving audio signals from a locally connected microphone. Electrical power connections are well-known, and are omitted for simplicity of illustration.

The Portable MNS Director includes a switch matrix which determines the transducer set(s) which receive the audio signal. In the embodiment shown, the switch matrix is “upstream” from the amplifiers; in another embodiment, the switch matrix could be “downstream” between the amplifiers and the transducers.

In one embodiment, the switch matrix is operated by a user-controlled set of switches. For example, there may be switches for setting the portable MNS loudspeaker to generate sound 11 in a 90° pattern (one out of four transducer sets is driven), a 180° pattern (two adjacent transducer sets are driven), a 270° pattern (three transducer sets are driven), or a 360° pattern (all transducer sets are driven). The particular sets thus selected may be predetermined or, in other words, hard wired. For example, transducers T1A and T1B may always be driven, and transducers T2A and T2B may be driven if any selector other than the 90° selector is activated, transducers T3A and T3B may be driven if either the 270° or 360° selector is activated, and transducers T4A and T4B may be driven only if the 360° selector is activated.

Or, alternatively, the Portable MNS Director may include a user-controlled set of switches for dynamically determining the orientation of the portable MNS loudspeaker. For convenience, these may be referred to as North, East, South, and West orientations, selected by an N selector switch, an E selector switch, a S selector switch, and a W selector switch, respectively (or a single dial switch which selects the position). If the portable MNS loudspeaker is physically placed in the correct orientation, these NESW selector switches will, in fact, produce the indicated directivity. Alternatively, the NESW switches may simply switch predetermined ones of the transducer sets on and off, giving the user more direct control over the sound directivity. This enables the user to select a non-contiguous group of transducer sets, for example to send sound N and S but not E or W.

The portable MNS system and Portable MNS Director are not limited to having exactly four selectable sets of transducers and four corresponding orientations; that is merely an example chosen to illustrate the principles of the invention.

Optionally, the portable MNS system may also include an Intelligibility Controller for performing a variety of functions upon the signals to be sent to the transducers. For example, it may include a low pass filter (LPF) with a user-settable control mechanism such as a knob, and a high pass filter (HPF) with a user-settable control mechanism such as a knob. These and other such filtering and signal processing means will enable the MNS system to be fine-tuned for maximum performance at a particular venue.

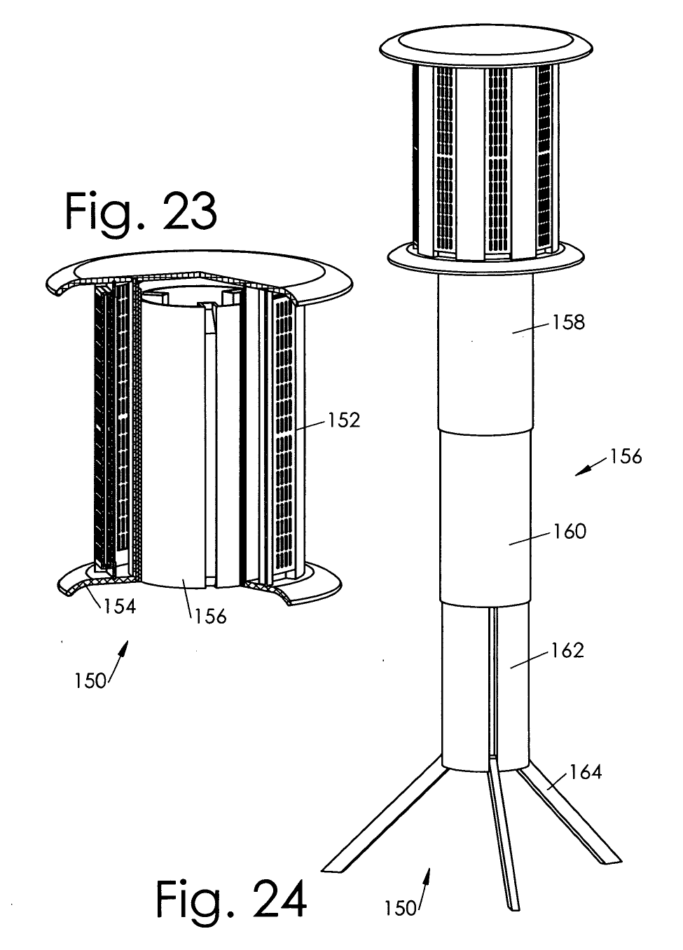

FIG. 23 illustrates another embodiment of a portable MNS system 150 having an MNS loudspeaker 152 equipped with a built-in base 156. The base is shown in a furled configuration. The lower ring 154 of the MNS loudspeaker may be modified to work with the base. For example, the lower ring may include an integral inner cylinder providing both a mounting fixture for the base as well as a rear wall of the enclosed air chamber behind the transducers. In one embodiment, the base is a tripod, but in other embodiments it could have other configurations.

FIG. 24 illustrates the portable MNS system 150 with the built-in base 156 in an unfurled configuration. The base includes a telescoping set of tubes 158, 160, 162 of any suitable number, length, and shape. The number and length may be selected to provide an optimal listening height for the MNS loudspeaker. In one embodiment, the lowermost telescoping tube is adapted with three or more deployable legs for stabilizing the MNS system, and may include a plurality of channels or recesses in which the legs are held when the base is furled. In another embodiment, the lowermost telescoping tube may be adapted for coupling with a permanent fixture (not shown) in the ground, stage, or other location at which the MNS may periodically be deployed. Such a fixture may be as simple as a vertical pipe stuck in the ground and cut off at ground level.

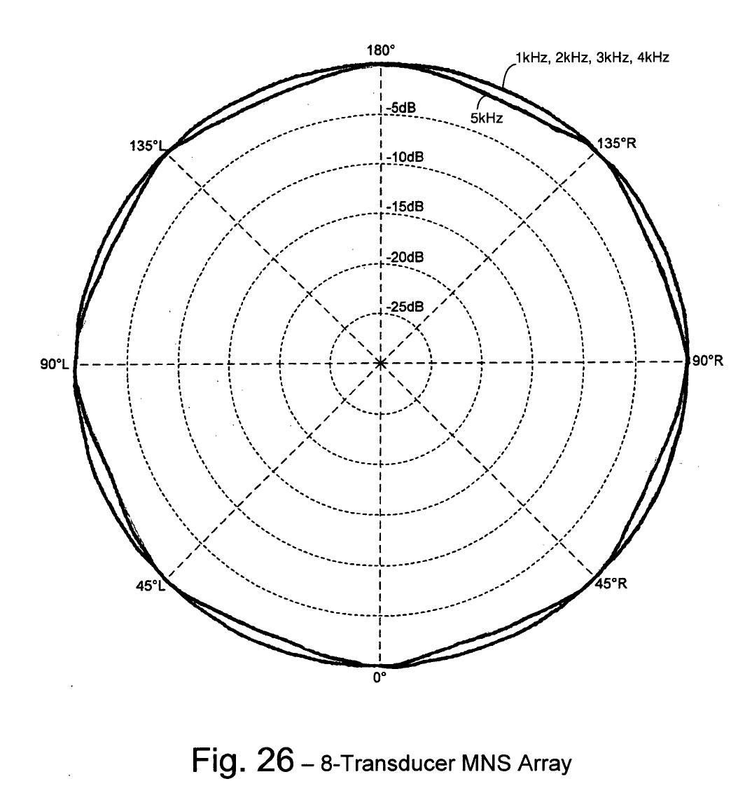

FIG. 26 is a polar response graph resulting from a computer simulation of the performance of an 8-transducer MNS system according to one embodiment of the present invention. At all frequencies in the 1 kHz to 4 kHz range, there is essentially no drop-off at any listening position. And even at 5 kHz, which is at the very upper end of what is considered important for human speech intelligibility, the 22.5° etc. listening positions have a mere 1-1.5 dB drop off. This 8-transducer system represents a truly vast improvement over the 4-transducer system of the prior art.

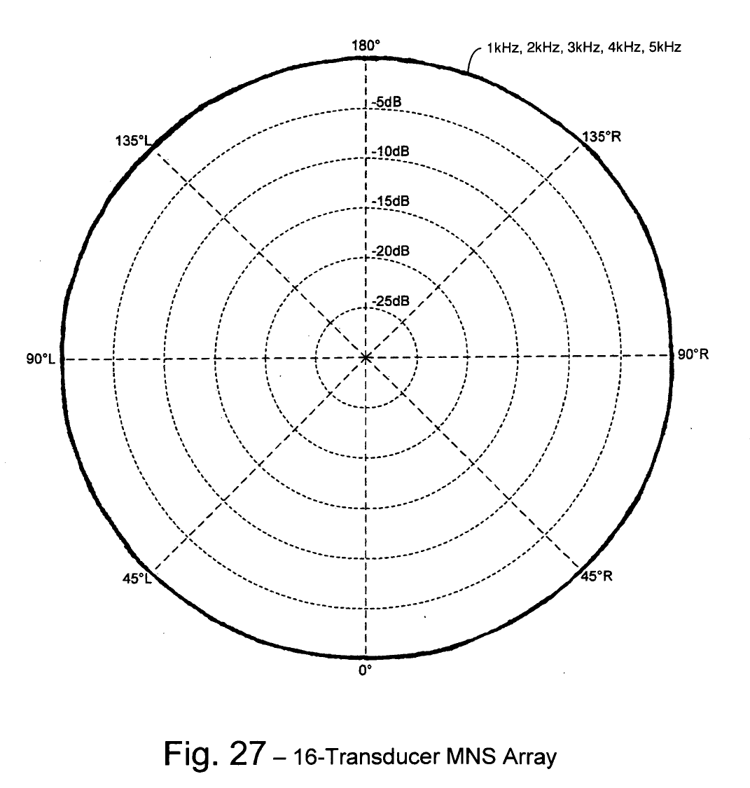

FIG. 27 is a polar response graph resulting from a computer simulation of the performance of a 16-transducer MNS system according to another embodiment of the present invention. At all frequencies in the 1 kHz to 5 kHz range, there is essentially no drop-off at any listening position. The 16-transducer system behaves almost exactly as a pulsating cylinder, in the frequency range of human speech intelligibility.

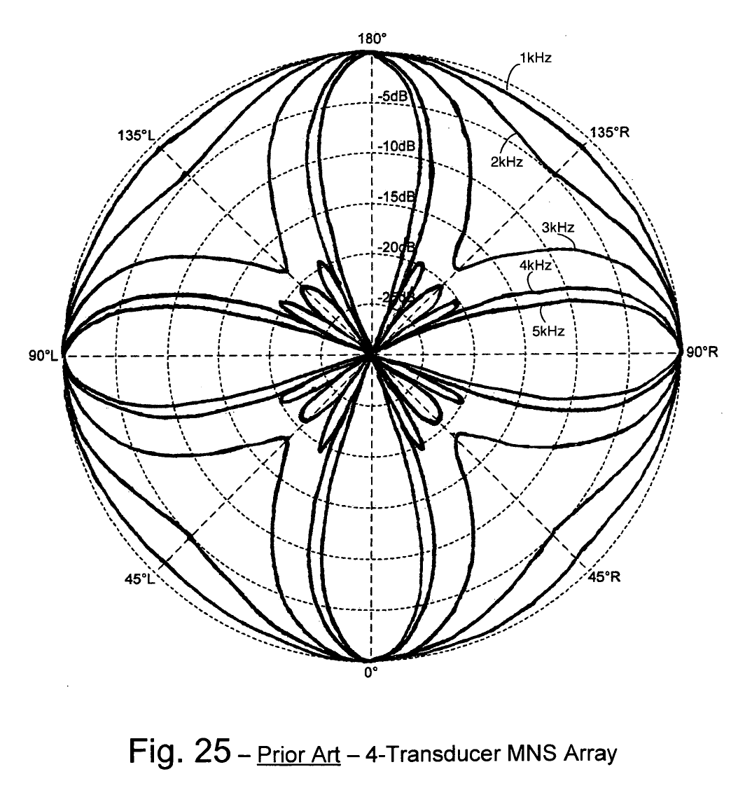

By comparing FIGS. 26 and 27 to FIG. 25, the significant improvement in speech intelligibility of this invention is readily observed.

### CONCLUSION

When one component is said to be “adjacent” another component, it should not be interpreted to mean that there is absolutely nothing between the two components, only that they are in the order indicated.

In some embodiments, the various transducers may not be of identical construction, and may have different widths, and may be on non-identical spacings.

The various features illustrated in the figures may be combined in many ways, and should not be interpreted as though limited to the specific embodiments in which they were explained and shown.

Those skilled in the art, having the benefit of this disclosure, will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A mass notification loudspeaker comprising:
a plurality of at least five elongated transducers each having a diaphragm whose height is at least twice its width;
wherein the transducers are coupled together to form a loudspeaker having a substantially cylindrical shape with the diaphragms facing outward;
wherein the transducers are disposed about an axis of the cylindrical shape on spacing no greater than 360°/8=45° average spacing;
wherein the transducers occupy a single contiguous group of positions about the axis having at least 90° edge-to-edge coverage.

2. The mass notification loudspeaker of claim 1 wherein:
the plurality of transducers comprises at least eight elongated transducers.

3. The mass notification loudspeaker of claim 2 wherein:
the plurality of transducers comprises at least twelve elongated transducers.

4. The mass notification loudspeaker of claim 3 wherein:
the plurality of transducers comprises at least sixteen elongated transducers.

5. The mass notification loudspeaker of claim 1 wherein:
wherein the transducers occupy a single contiguous group of positions about the axis having at least 180° edge-to-edge coverage.

6. The mass notification loudspeaker of claim 5 wherein:
wherein the transducers occupy a single contiguous group of positions about the axis having at least 270° edge-to-edge coverage.

7. The mass notification loudspeaker of claim 6 wherein:
wherein the transducers occupy a single contiguous group of positions about the axis having 360° edge-to-edge coverage.

8. The mass notification loudspeaker of claim 1 for mounting to a pole and further comprising:
a rain cap coupled to upper ends of the plurality of transducers and covering an end of the cylindrical shape and adapted for mounting to a top end of the pole.

9. The mass notification loudspeaker of claim 8 further comprising:
a base coupled to lower ends of the plurality of transducers and having an opening for passing over the top end of the pole.

10. The mass notification loudspeaker of claim 8 further comprising:
an outer frame to which the transducers are coupled.

11. The mass notification loudspeaker of claim 10 further comprising:
an inner cylinder coupled to the rain cap and to the base, and enclosing an air volume between the inner cylinder, the frame and transducers, the rain cap, and the base.

12. The mass notification loudspeaker of claim 1 wherein the transducers comprise one of:
planar magnetic transducers; and
ribbon transducers.

13. The mass notification loudspeaker of claim 1 wherein:
the substantially cylindrical shape comprises a cone section.

14. The mass notification loudspeaker of claim 13 wherein:
each of the transducers has a substantially trapezoidal shape.

15. The mass notification loudspeaker of claim 1 further comprising:
a frame having interleaved segments for coupling to the transducers and segments for providing lateral spacing between the transducers.

16. The mass notification loudspeaker of claim 1 further comprising:
means for selecting a subset of the transducers to be driven with a voice signal.

17. The mass notification loudspeaker of claim 16 wherein the means for selecting comprises:
means for selecting from a plurality of pre-determined groups of adjacent transducers, to determine a broadcast angle of sound from the mass notification loudspeaker.

18. The mass notification loudspeaker of claim 17 wherein the means for selecting further comprises:
means for setting a logical orientation of the transducers.

19. The mass notification loudspeaker of claim 1 further comprising:
a telescoping stand coupled to the transducers and retractable at least partially within a the cylindrical shape.

20. A mass notification loudspeaker comprising:
a rain cap;
a plurality of N elongated transducers coupled to the rain cap and forming a substantially cylindrical shape having an axial space within the plurality of transducers;
wherein N is a positive integer greater than seven;
wherein the transducers are disposed at substantially equal 360° N positions about the cylindrical shape.

21. The mass notification loudspeaker of claim 20 wherein:
N is greater than eleven.

22. The mass notification loudspeaker of claim 21 wherein:
N is greater than fifteen.

23. The mass notification loudspeaker of claim 20 further comprising:
a frame to which the transducers are coupled.

24. The mass notification loudspeaker of claim 23 further comprising:
a base ring coupled to the transducers
an inner cylinder coupled to the rain cap and the base ring; and
an enclosed air space enclosed by the rain cap, base ring, frame, transducers, and inner cylinder.

25. The mass notification loudspeaker of claim 20 further comprising:
a base ring coupled to the transducers
an inner cylinder coupled to the rain cap and the base ring; and
an enclosed air space enclosed by the rain cap, base ring, transducers, and inner cylinder.
